(19) United States
(12) Patent Application Publication
(10) Pub. No.: US 2015/0311713 A1
(43) Pub. Date: Oct. 29, 2015

(54) Service-based Approach Toward Management of Grid-Tied Microgrids

(71) Applicant: NEC Laboratories America, Inc., Princeton, NJ (US)

(72) Inventors: Babak Asghari, San Jose, CA (US); Ratnesh Sharma, Fremont, CA (US); Ali Hooshmand, Campbell, CA (US)

(21) Appl. No.: 14/680,848

(22) Filed: Apr. 7, 2015

Related U.S. Application Data
(60) Provisional application No. 61/985,068, filed on Apr. 28, 2014.

(51) Int. Cl. H02J 3/00; G05B 15/02

(52) U.S. Cl. CPC H02J 3/00; G05B 15/02

(57) ABSTRACT

Systems and methods are disclosed for providing service based interactions between a utility and a microgrid by adjusting power flow profile at a point of common coupling (PCC) between a microgrid and a utility, wherein the power flow profile is adjusted to achieve a predetermined objective function based on a utility request; delivering different services to the utility at different periods of time by altering its internal operation of distributed generators, energy storage units, and demands as a multi-purpose microgrid; and managing the microgrid to deliver services to the utility and reduce its operational cost simultaneously.

This application is a non-provisional of Application Ser. 61/985,068 filed 2014 Apr. 28, the content of which is incorporated by reference.

### BACKGROUND

This application relates to a service-based framework for energy management of microgrids.

A growing number of distributed generation (DG) and energy storage installations by the end-users have introduced new challenges and opportunities for reliable and efficient operation of the grid. The electricity demand is increasing in the world but it is also getting equipped with automated control systems which add more flexibility to the electricity consumption. Moreover, advanced metering infrastructure (AMI) have provided the necessary tools to realize a smart grid in which two way communication between utilities and end-users as well as real-time measurement and monitoring of consumption/generation at each node on the grid is possible.

The evolution of smart grid has resulted in the emergence of intelligent structures called microgrids that can exchange power, information, and control signals with each other and the rest of the grid as requested. A grid-tied microgrid is an aggregated system consisting of local loads, energy resources, energy storage units, and a utility connection to import/export power from the grid if necessary. One of the main objectives of operating a microgrid is to reduce final cost of electricity supplying the demand in the microgrid.

Utilities have already started to take advantage of the smart grid by introducing demand response programs for demand management in the grid. In price based programs (PBP) a microgrid adjusts its operation to minimize its cost based on dynamic tariffs set by the utility. In incentive based programs (IBP) participants usually receive payments as a credit based on their performance in the programs.

### SUMMARY

In one aspect, systems and methods are disclosed for providing service based interactions between a utility and a microgrid by adjusting power flow profile at a point of common coupling (PCC) between a microgrid and a utility, wherein the power flow profile is adjusted to achieve a predetermined objective function based on a utility request; delivering different services to the utility at different periods of time by altering its internal operation of distributed generators, energy storage units, and demands as a multi-purpose microgrid; and managing the microgrid to deliver services to the utility and reduce its operational cost simultaneously.

In another aspect, an energy management framework is disclosed in which various services can be delivered by a microgrid to the utility. A service is defined in terms of an adjustment in power flow profile at the point of common coupling that should be enforced during the service period. A microgrid equipped with a diverse set of generations, storage units, and flexible demands can provide a range of services for reliable and economic operation of the grid. A multi-objective optimization approach is used to formulate the energy management problem based on service definition and operational cost of a microgrid. A set of Pareto optimal solutions can be calculated for operation of a microgrid during each service period.

In yet another aspect, first a service is defined as an adjusted power flow profile at the point of common coupling (PCC) between a microgrid and a utility. The power flow profile is adjusted in a way to achieve a certain objective function based on the request by the utility. Then, a multi-purpose microgrid is described as a microgrid which delivers different services to the utility at different periods of time by altering its internal operation of distributed generators, energy storage units, and demands. Finally, management methods for a microgrid to deliver various services to the utility and reduce its operational cost simultaneously can be done.

Implementations of the system may include one or more of the following. Service-based interaction between a utility and a microgrid can use a framework in which the interaction between microgrid and utility is based on the service (power profile), which is exchanged at the point of common coupling (PCC). The multi-purpose microgrid includes a microgrid which constantly adjusts its internal operation points (generator, storage and load setpoints) to deliver various services at the PCC as requested by the utility. Service-as-a-constraint operation is provided i In which the service requested by the utility from the micro grid is a constraint that must be satisfied at the PCC. The microgrid management system solves an optimization problem to minimize the microgrid operational cost considering all internal constraint plus the constraint imposed by the service request. The solution to this optimization is the schedule for operation of all devices in the microgrid during the service period. A service-as-an-objective operation is provided in which the service requested by the utility is a function that needs to be minimized (maximized) at the PCC. The system provides bi-objective optimization of microgrid cost and service quality: When service is an objective, microgrid management system solves a bi-objective optimization problem to find the optimal schedule for the micro grid operation. One objective function is microgrid operational cost and the other one is the service objective function. The solution to bi-objective optimization is not unique and consists of a set of optimal solutions (Pareto front). The Pareto front is then being used by the management system or the operator to select the optimal schedule for micro grid operation depending on the contract with the utility. A weighted-sum optimization approach can be used in which the weigthed-sum method is used to find the Pareto front of the bi-optimization problem. Epsilon-constraint optimization approach can also be used in which the epsilon-constraint optimization approach is used to find the Pareto front of the bi-optimization problem.

Advantages of the preferred embodiments may include one or more of the following. The definition of a multi-purpose microgrid which switches its role as provider of different services to the utility enable more benefits for the microgrid owners without sacrificing its internal operation. The approach to solve microgrid management problem considering both internal cost and the service requested by the utility provide advantages over current management systems which are either designed to reduce the operational cost or to provide a single service to the utility. The system provides more flexibility for microgrids to interact with the utility and increases the revenues for microgrid owners as it can provide different services to the utility. Two case studies related to peak shaving and minimum power fluctuation services have been performed to verify these advantages.

### BRIEF DESCRIPTION OF THE DRAWINGS

FIGS. 1A-1B shows an exemplary process for optimizing operation of a microgrid when it delivers a service to the utility.

FIG. 2 shows an exemplary system for running the process of FIGS. 1A-1B to control a microgrid.

### DETAILED DESCRIPTION

A general framework is detailed below for optimizing operation of a microgrid when it delivers a service to the utility. A multi-objective optimization approach is utilized because in this scenario two different (and sometimes contradictory) objective functions related to microgrid operational cost (internal) and quality of delivered service to the grid (external) should be optimized at the same time. The multi-objective optimization solution is usually not unique and consists of a set of points (Pareto front) that all fit a predetermined definition for an optimum [6]. Two case studies for a microgrid with flexible loads and an energy storage unit delivering peak shaving and minimum power fluctuation services to the utility are studied. It is shown that the Pareto front solution in each case provides insight about how to operate the microgrid. The rest of this paper is organized as follows. Section II describes the operational cost formulation for a grid-tied microgrid with distributed generations, flexible loads, and storage units. Section III defines the service objective function.

The combination of generation, storage, and flexible load which is present in a microgrid provides a powerful tool for adjusting the power flow between the grid and the microgrid at the point of common coupling (PCC). The power flow profile (P_{G}) at PCC can be adjusted over a period of time to achieve a certain objective function (service) requested by the utility. In this way a microgrid not only serves the internal purpose of reducing its operational cost, but also delivers a wide range of services to the grid operator to improve grid conditions.

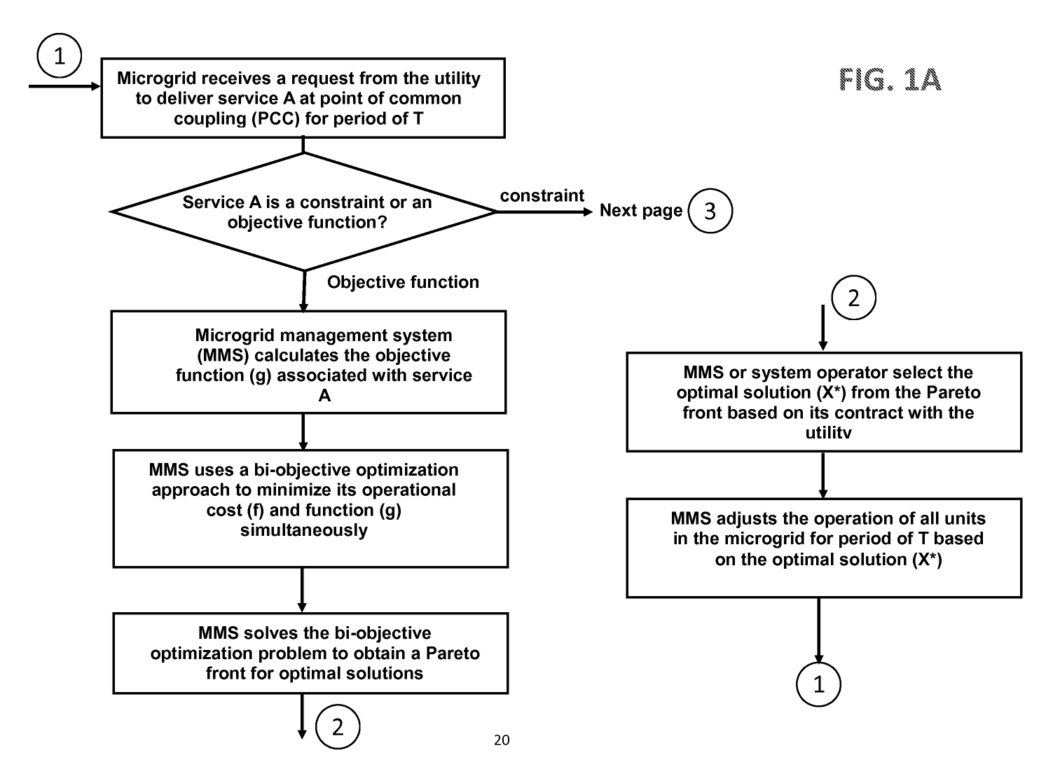

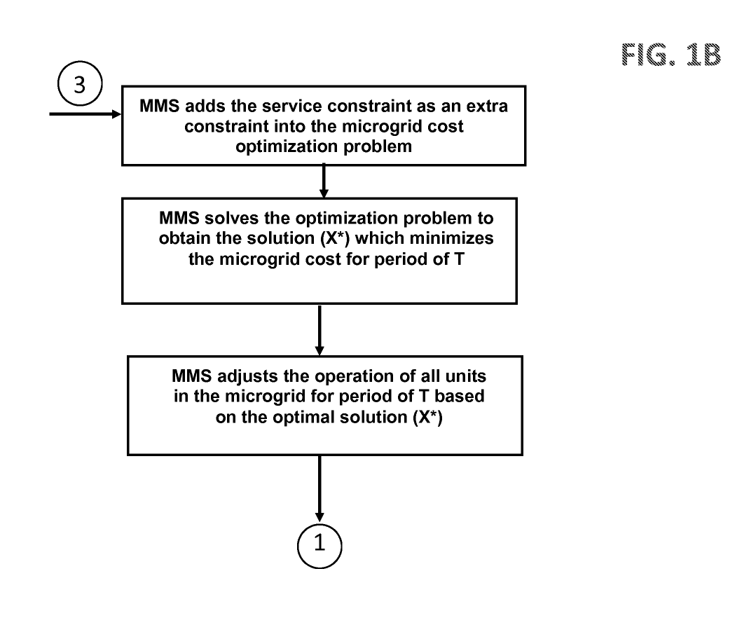

Turning now to FIGS. 1A-1B, a process for optimizing operation of a microgrid when it delivers a service to the utility. First, the microgrid receives a request from the utility to deliver service A at a point of common coupling (PCC) for a period T. Next, the process checks if service A is a constraint or an objective function. If the service is a constraint, the process jumps to 3 of FIG. 1B.

Otherwise, the microgrid management system (MMS) determines an objective function (g) associated with service A and then the MMS uses a bi-objective optimization approach to minimize its operational cost f and function g simultaneously. The MMS then solves the bi-objective optimization problem to obtain a Pareto front for optimal solutions and then jumps to connector 2 where the MMS or system operator selects the optimal solution (X*) from the Pareto front based on its contract with the utility. The MMS adjusts the operation of units in the microgrid for the period of T based on the optimal solutions (X*) and then jumps to connector 1.

Referring now to FIG. 1B, from connector 3, the MMS adds the service constraint as an extra constraint into the microgrid cost optimization problem. The MMS then solves the optimization problem to obtain the solution X* which minimizes the microgrid cost for the period of T. The MMS then adjusts the operation of units in the microgrid for the period of T based on the optimal solution X* and then jumps to connector 1 of FIG. 1A.

Microgrid Operational Cost is discussed next. The energy management system (EMS) of a microgrid is usually designed in a way to minimize operational cost of the microgrid with minimum impact on the user's comfort. This minimization problem for a grid-tied microgrid consisting of distributed generations, energy storage units and flexible loads over a time period of T can be written as:

$$min f := {\sum }_{t = 0}^{T} {C}_{G} ( t ) {P}_{G} ( t ) + {C}_{DG} ( t ) {P}_{DG} ( t ) + {C}_{Batt} ( t ) \vert {P}_{Batt} ( t ) \vert + {C}_{DM} ( t ) \qquad ( 1 )$$

where ƒ is the objective function (operational cost). C_{G}, P_{G}, C_{DG}, P_{DG}, C_{Batt}, P_{Batt}, and C_{DM} are gird tariff, grid power, DG generation cost, DG power, battery wear cost, battery power, and demand management cost respectively.

DG generation cost usually depends on DG fuel cost. Renewable generation cost is assumed to be free as there is no fuel cost involved in the electricity generation from these resources. An average battery wear cost based on rated battery parameters can be calculated as follows:

$${C}_{Batt} = \frac{{C}_{Batt}^{capital}}{{L}_{rated} \times {DoD}_{rated} \times {C}_{rated} \times 2} \qquad ( 2 )$$

where C_{Batt}^{capital}, L_{rated}, DoD_{rated}, and C_{rated} are capital cost of the battery($), rated cycles, rated depth of discharge, and rated capacity respectively. The battery wear cost in (2) is divided by two and then multiplied by the absolute value of battery power in (1) so that equal charge and discharge powers have the same impact in terms of battery wear cost.

Demand management cost of a microgrid, C_{DM}, in (1) is captured through a disutility function. This function models the dissatisfaction of the user based on the deviation of the actual electricity consumption from customer scheduled consumption, as follows:

C_{DM}(t)=α|P_{D}(t)−P_{D}*(t)| (3)

where P_{D}(t) and P_{D}*(t) are actual and scheduled (target) demand at time t respectively. α is the load sensitivity factor determined based on the impact of deviation in demand on the user dissatisfaction.

The cost minimization problem is subjected to following constraints:

(1) Supply-Demand balance which is an equality constraint and the primary task of management system. This constraint is formulated as follows:

P_{G}(t)+P_{DG}(t)+P_{Batt}(t)=P_{D}(t) (4)

which means the summation of generated power by grid, battery, (Distributed generations including renewable sources) should be equal to demand at each time.

(2) Battery state of charge (SoC) difference equation:

SoC(t+1)=SoC(t)−kP_{Batt}(t) (5)

in which SoC(t) is battery state of charge at time t and k is a coefficient which converts battery power into SoC changes.

(3) Upper and lower bounds for battery SoC which by considering the SoC difference equation (5) will be a dynamic inequality constraint:

SoC^{min}≦SoC(t)≦SoC^{max} (6)

(4) Grid power, DG power, and demand are always greater than or equal to zero. Note that in this paper it is assumed that sell back of power to the utility is not allowed.

0≦P_{D}(t),P_{G}(t),P_{DG}(t) (7)

The solution of minimization problem in (1) subject to (4)-(7) provides optimal setpoints for operation of generation, storage, and demand in a microgrid in order to minimize its operating cost over a period of T. Decision variables for this optimization problem are P_{G}, P_{DG}, P_{Batt}, and P_{D}. (1) can be reformulated into a convex LP problem by using auxiliary variables instead of absolute values.

Service Objective is detailed next. A grid-tied microgrid is an aggregated entity which is electrically connected to the utility at the point of common coupling (PCC). Thus, a service from a microgrid to the utility is defined as a function of the grid power (P_{G}) that needs to be minimized over a period of time (T). The original definition of a service requested by the utility might not be in the form of a minimization problem as will be shown in case Study I. Therefore it is necessary to transfer the original service request into a minimization problem as follows:

$$min g := {\sum }_{t = 0}^{T} G ( {P}_{G} ) \qquad ( 8 )$$

where g is the objective function for the service delivery and G is the service function.

The requested service by the utility could vary multiple times in a day depending on the grid conditions. For some of these requests a microgrid might not be able to deliver the service to its full extent because of its operational constraint such as (4)-(7). The microgrid EMS is also concerned about microgrid operational cost as discussed in Section II. Therefore, in situations where the requested service is in mutual conflict with a microgrid operational cost, the microgrid EMS might decide to compromise the quality of delivered service in favor of reduction in microgrid cost.

Turning now to Multi-Objective Optimization, to provide a decision-making framework for a micorogrid EMS when confronted with different objectives, a multi-objective (bi-objective) optimization approach can be used. In this way the EMS can evaluate the consequences of a decision with respect to all the objective functions considered. When a new service request from the utility is received, the multi-objective problem is defined and solved by a microgrid EMS as follows:

$$min [ f , g ] \\ subject to ( 4 ) - ( 7 ) \qquad ( 9 )$$

In contrast to a single-objective optimization, there is no single global solution to a multi-objective optimization. Usually it is necessary to determine a set of optimal points called Pareto front. Each point in the Pareto front is a solution where there exist no other feasible solution that improves at least one objective function without compromising any other objective function[9]. The Pareto front for multi-objective optimization in (9) can be obtained using the weighted sum method [6] which reduces it to a scalar problem of the form:

$$min ( \frac{{w}_{1}}{{sf}_{1}} f + \frac{{w}_{2}}{{sf}_{2}} g ) \qquad ( 10 )$$

where w₁ and w₂ are weighting factors and sf₁ and sf₂ are scale factors for function ƒ and g respectively.

Proper scaling (normalization) of objective functions in weighted sum method is important to ensure the consistency of optimal solutions with decision maker preferences. Different methods to calculate the scaling factors in weighted sum method are discussed in [9]. To ensure a convex combination of objectives, weighting factors are chosen such that:

w₁+w₂=1,0≦w₁,w₂ (11)

By varying the weighting factors in (10) and resolving the scalar optimization problem, different points of Pareto front can be calculated. Once the Pareto front is obtained, a decision maker can pick a desirable operation schedule to be followed during the service period.

Next, two exemplary case studies for optimal operation of a microgrid delivering two different services to the utility at separate time intervals are presented. These examples are discussed to illustrate the operation of the system, but the invention is not limited to the specifics of these examples. It is assumed that the sample microgrid only consists of flexible loads, an energy storage unit and a grid connection. However, the same approach can be applied to microgrids with distributed generations. All simulation studies are carried out in MATLAB using the Optimization Toolbox for a 3 hour service period with sampling time of 15 minutes. Microgrid parameters are given in Table 1. The target demand during the service period is defined as:

P_{D}*(t)=[0.1,0.1,0.3,1.5,0.2,0.3,0.5,0.3,2,2,2,0.1] kW (12)

TABLE 1
Microgrid Parameters

| | |
|---|---|
| Battery Capacity (Ah) | 60 |
| Battery Voltage (V) | 48 |
| Battery Minimum SoC (%) | 50 |
| Battery Maximum SoC (%) | 100 |
| Battery Initial SoC (%) | 50 |
| Grid Tariff ($/kWh) | 0.2 |

In a peak shaving case study, the requested service by the utility from the microgrid is peak shaving (PS). To deliver this service, the microgrid is expected to keep its imported power from the grid below a predetermined threshold during the service period. Although this service can be added as an extra constraint in the microgrid cost optimization of (1)-(7), it is desirable to formulate it as an independent minimization problem to be compatible with the general multi-objective optimization approach discussed in Section IV. For this purpose, the peak shaving service can be converted to a minimization problem be defining function gₚₛ as follows:

$$min {g}_{ps} := {\sum }_{t = 0}^{T} max \{ {P}_{peak \text{-} shaving} , {P}_{G} ( t ) \} - {P}_{peak \text{-} shaving} \qquad ( 13 )$$

where P_{peak-shaving} is a constant for peak shaving threshold.

It can be seen from (13) that gₚₛ is equal to zero only if peak shaving constraint is satisfied completely during the entire service period. Depending on the duration and amount of violation from the peak shaving threshold during the service period, gₚₛ can assume positive values. (13) can be transformed into a LP problem by using the dummy variable Pₘₐₓ as follows:

$$min {g}_{ps} := {\sum }_{t = 0}^{T} {P}_{max} ( t ) - {P}_{peak \text{-} shaving} \qquad ( 14 )$$

subject to:

P_{peak-shaving}≦Pₘₐₓ(t),P_{G}(t)≦Pₘₐₓ(t) (15)

The Pareto front for peak-shaving service can then be obtained by solving the bi-objective optimization problem using (1) and (14) as the objective functions and (4)-(7), (15) as the constraints. To generate a well-distributed solution along the entire Pareto front region, an adaptive weighted sum method [10] is utilized in this case study.

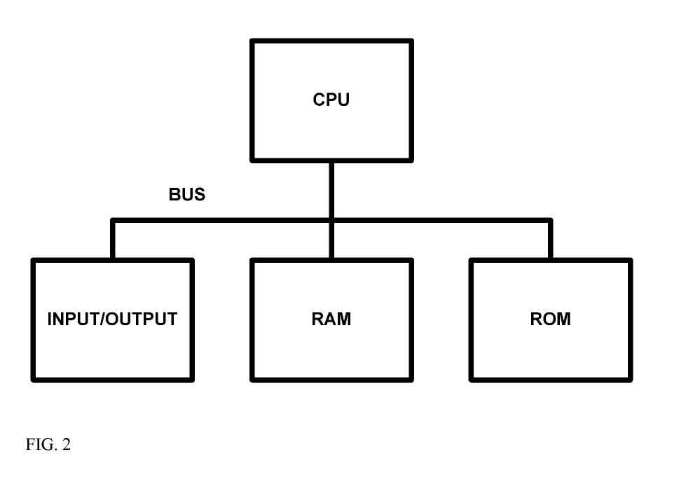

The microgrid EMS or system operator can use the Pareto front plots in FIG. 2 to chose the optimal operation schedule during the service period. For example the EMS might decide to provide full peak shaving service in scenario 2 because its impact on microgrid operation cost is less than 38%. However, in Scenario 1 partial or no peak shaving might be preferred because a full peak shaving will increase the microgrid operating cost by 370% compared to when no peak shaving is performed.

To compare the optimal microgrid schedule for scenarios 1 and 2, the grid power (P_{G}) and demand (P_{D}) profiles during the service period for solution points 1 and 2 from the Pareto fronts show that the optimal demand schedule (P_{D}) follows the target demand (P_{D}(t)). This is because the load sensitivity factor (α) set by the user is equal to 10 which makes any load shedding expensive and thus non-optimal. Also, as expected from the Pareto fronto plot, the optimal grid power in scenario 1 (P_{G1}) is completely regulated below or equal to the peak-shaving threshold of 1 kW. However, in scenario 2 only partial peak shaving during the service period is scheduled to avoid excessive operation cost. Battery SoC variation (charge and discharge events) scheduled for scenario 2 is less than scenario 1 in order to reduce battery wear cost and therefore reduce the overall microgrid operation cost.

In the second case study, minimum power fluctuation (MPF) service is studied. To deliver this service to the utility, a microgrid needs to minimize the grid power (P_{G}) fluctuation at the PCC during the service period. By providing this service a microgrid can contribute to grid stability and reduce the necessary amount of reserve on the network. The minimization problem associated with this service can be described in terms of the grid power variance during the service period by defining function g_{mpf} as follows:

$$min {g}_{mpf} := \frac{1}{T} {\sum }_{t = 0}^{T} {( {P}_{G} ( t ) - {μ}_{{P}_{G}} )}^{2} \qquad ( 16 )$$

where μ_{P}_{_{G}} is the average grid power during the service period:

$${μ}_{{P}_{G}} = \frac{1}{T} {\sum }_{t = 0}^{T} {P}_{G} ( t ) \qquad ( 17 )$$

After some algebraic manipulation, the objective function g_{mpf} can be written in a standard quadratic programming (QP) format as follows:

$${g}_{mpf} = \frac{1}{T} {\overline{P}}_{G}^{T} ( I - \frac{1}{T} Λ ) {\overline{P}}_{G} \qquad ( 18 )$$

where P̅_{G} is the grid power vector during the service period. I is the Identity matrix and Λ is a matrix of ones.

By defining MPF service function as in (18) a QP solver can be utilized to calculate the Pareto front for bi-objective optimization of (1) and (18) with (4)-(7) as the constraints. Similar to Case Study I, an ideal service (zero power fluctuation at PCC) can be delivered by the microgrid to the utility in both scenarios. However the adverse impact of ideal service delivery on microgrid operation cost in scenario 1 is 55% which is considerably less than scenario 2 (320%). A Pareto front can be used by the microgrid EMS or system operator to decide upon the optimal operation schedule during the MPF service period.

In a smart grid era with advanced communication infrastructure in place and abundance of microgrids connected to the bulk distribution system, it is necessary to redefine the nature of interaction between utilities and microgrids. Utilities can request a wide range of services from microgrids at different time intervals to achieve more efficient and stable operation of the grid. Similarly, microgrids can deliver various services to the utility by adjusting operation of their diverse resources such as distributed generations, energy storage units, and flexible loads. In this paper a multi-objective optimization framework for service-based management of grid-tied microgrids is proposed. In this framework the first objective is to minimize operating cost of a microgrid as the main driving factor for its utilization. For this minimization problem a comprehensive cost model including generation, storage, and demand management costs is discussed in the paper. In the second objective power flow profile at the point of common coupling is adjusted over a period of time to deliver a service to the utility. It is shown that weighted sum method can be used to obtain a set of optimal solutions (Pareto front) based on the service definition and parameters of the microgrid. To show the effectiveness of proposed approach, simulation results for two case studies related to peak shaving and minimum power fluctuation services delivered by a sample microgrid to the utility are presented and discussed. Pareto front solutions obtained from the proposed framework can be used by energy management systems or microgrid operators to define optimal operation schedule for different components of a microgrid during each service period.

Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next in FIG. 2. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for providing service based interactions between a utility and a microgrid, comprising:
adjusting power flow profile at a point of common coupling (PCC) between a microgrid and a utility, wherein the power flow profile is adjusted to achieve a predetermined objective function based on a utility request;
delivering different services to the utility at different periods of time by altering its internal operation of distributed generators, energy storage units, and demands as a multi-purpose microgrid; and
managing the microgrid to deliver services to the utility and reduce its operational cost simultaneously.

2. The method of claim 1, comprising providing service-based interaction between a utility and a microgrid.

3. The method of claim 2, comprising a framework in which the interaction between microgrid and utility is based on the service (power profile) which is exchanged at the point of common coupling (PCC).

4. The method of claim 1, wherein the multi-purpose microgrid constantly adjusts its internal operation points (generator, storage and load setpoints) to deliver services at the PCC as requested by the utility.

5. The method of claim 1, comprising providing service-as-a-constraint where a service requested by the utility from the micro grid is a constraint satisfied at the PCC.

6. The method of claim 1, comprising solving an optimization problem to minimize the microgrid operational cost considering all internal constraint plus the constraint imposed by the service request.

7. The method of claim 6, comprising applying the optimization to a schedule for operation of devices in the microgrid during the service period.

8. The method of claim 1, comprising providing service-as-an-objective operation where service requested by the utility is a function minimized or maximized at the PCC.

9. The method of claim 1, comprising performing bi-objective optimization of microgrid cost and service quality.

10. The method of claim 9, comprising solving a bi-objective optimization problem to find an optimal schedule for the micro grid operation when service is an objective.

11. The method of claim 1, comprising solving microgrid operational cost and a service objective function.

12. The method of claim 1, wherein a solution to bi-objective optimization is not unique and includes a set of optimal solutions (Pareto front).

13. The method of claim 12, wherein the Pareto front is used by a management system or an operator to select the optimal schedule for micro grid operation depending on a contract with the utility.

14. The method of claim 1, comprising providing a weighted-sum optimization of the cost and objective function.

15. The method of claim 14, where the weighted-sum method is used to find a Pareto front of the bi-optimization problem.

16. The method of claim 1, comprising applying Epsilon-constraint optimization approach.

17. The method of claim 16, wherein the epsilon-constraint optimization approach is used to find a Pareto front of the bi-optimization problem.

18. The method of claim 1, comprising minimizing costs for a grid-tied microgrid consisting of distributed generations, energy storage units and flexible loads over a time period of T as:
$$min f := {\sum }_{t = 0}^{T} {C}_{G} ( t ) {P}_{G} ( t ) + {C}_{DG} ( t ) {P}_{DG} ( t ) + {C}_{Batt} ( t ) \vert {P}_{Batt} ( t ) \vert + {C}_{DM} ( t )$$
where ƒ is the objective function (operational cost). C_{G}, P_{G}, C_{DG}, P_{DG}, C_{Batt}, P_{Batt}, and C_{DM} are gird tariff, grid power, DG generation cost, DG power, battery wear cost, battery power, and demand management cost respectively.

19. The method of claim 1, comprising minimizing
$$min g := {\sum }_{t = 0}^{T} G ( {P}_{G} )$$
where g is the objective function for the service delivery and G is the service function.

20. The method of claim 1, comprising providing service as a constraint where g must be less than a constant.
